(19) United States
(12) Patent Application Publication
(10) Pub. No.: US 2024/0311221 A1
(43) Pub. Date: Sep. 19, 2024

(54) DETECTION AND INTERPRETATION OF LOG ANOMALIES

(71) Applicant: Adobe Inc., San Jose, CA (US)

(72) Inventors: Jaeho Bang, Hwaseong-si (KR); Sungchul Kim, San Jose, CA (US); Ryan A. Rossi, San Jose, CA (US); Tong Yu, Fremont, CA (US); Handong Zhao, Cupertino, CA (US)

(73) Assignee: Adobe Inc., San Jose, CA (US)

(21) Appl. No.: 18/120,773

(22) Filed: Mar. 13, 2023

(51) Int. Cl. G06F 11/07; G06N 20/00

(52) U.S. Cl. CPC G06F 11/0769; G06F 11/0778; G06N 20/00

(57) ABSTRACT

In implementations of systems for detection and interpretation of log anomalies, a computing device implements an anomaly system to receive input data describing a two-dimensional representation of log templates and timestamps. The anomaly system processes the input data using a machine learning model trained on training data to detect anomalies in two-dimensional representations of log templates and timestamps. A log anomaly is detected in the two-dimensional representation using the machine learning model based on processing the input data. The anomaly system generates an indication of an interpretation of the log anomaly for display in a user interface based on a log template included in the two-dimensional representation.

### BACKGROUND

Applications record runtime information by generating log data describing semi-structured log messages printed based on runtime operations. The log data is usable to monitor, administrate, and/or troubleshoot the applications. If an incident or critical issue related to an application is observed, then system operators analyze log messages described by log data generated by the application to identify a root cause of the incident/issue in order to resolve the incident/issue.

### SUMMARY

Techniques and systems for detection and interpretation of log anomalies are described. In an example, a computing device implements an anomaly system to receive input data describing a two-dimensional representation of log templates and timestamps. The anomaly system processes the input data using a machine learning model trained on training data to detect anomalies or anomalous patterns in two-dimensional representations of log templates and timestamps.

A log anomaly is detected in the two-dimensional representation using the machine learning model based on processing the input data. For example, the anomaly system identifies a particular log template included in the two-dimensional representation that contributes to the log anomaly. The anomaly system generates an indication of an interpretation of the log anomaly for display in a user interface based on the particular log template that contributes to the log anomaly.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ digital systems and techniques for detection and interpretation of log anomalies as described herein.

FIG. 2 depicts a system in an example implementation showing operation of an anomaly module for detection and interpretation of log anomalies.

FIG. 3 illustrates a representation of unprocessed log messages.

FIG. 4 illustrates a representation of a pre-process module.

FIG. 5 illustrates a representation of training a machine learning model.

FIG. 6 illustrates a representation of generating anomaly data using a trained machine learning model.

FIG. 7 illustrates a representation of generating an indication of an interpretation of a log anomaly.

FIG. 8 is a flow diagram depicting a procedure in an example implementation in which an indication of an interpretation of a log anomaly is generated for display in a user interface.

FIG. 9 is a flow diagram depicting a procedure in an example implementation in which a particular log template included in a two-dimensional representation is identified as contributing to a log anomaly detected in the two-dimensional representation.

FIG. 10 illustrates an example system that includes an example computing device that is representative of one or more computing systems and/or devices for implementing the various techniques described herein.

### DETAILED DESCRIPTION

### Overview

Log data generated by applications to record runtime information often includes thousands or millions of lines of semi-structured log messages. In scenarios in which it is not practical for anomalies in the log data to be detected by a system operator, log anomaly detection systems are usable to automatically classify instances of the log data as anomalies or not anomalies. Some conventional systems for log anomaly detection are limited to generating binary classifications for instances of log data (e.g., an anomaly is detected) and are not capable of generating an explanation or interpretation of a detected anomaly. Other conventional systems are capable of learning to generate additional information supporting a binary classification for an instance of the log data; however, these systems require labeled training data to learn to generate the additional information. As a result, the conventional systems are also limited to detecting anomalies in datasets that are similar to the labeled training data. In order to overcome these limitations, techniques and systems for detection and interpretation of log anomalies are described.

In an example, a computing device implements an anomaly system to receive log data describing unprocessed log messages. For instance, the anomaly system generates training data for training a machine learning model based on the log data using a reconstruction loss of an autoencoder. To do so in one example, the anomaly system parses the unprocessed log messages using a log parser to extract log templates and corresponding timestamps from the unprocessed log messages. For example, the anomaly system groups the extracted log templates into groups based on time windows of the corresponding timestamps.

In one example, the anomaly system implements the autoencoder to learn a general distribution of the log data by processing the groups of log templates. After the autoencoder has learned the general distribution of the log data, the anomaly system leverages the autoencoder to identify anomalies in the log data which do not follow the general distribution of the log data. To do so, the anomaly system computes reconstruction losses for instances of the log data which correspond to a normalized difference between data input into an encoder of the autoencoder and data output from a decoder of the autoencoder. The anomaly system identifies and pseudo-labels instances of the log data having a reconstruction loss that is greater than a threshold (e.g., 3 percent) as anomalies.

The anomaly system generates the training data for training the machine learning model based on instances of the log data having the pseudo-labels (e.g., anomalies) and instances of log data not having the pseudo-labels (e.g., non-anomalies). After generating the training data, the anomaly system trains the machine learning model to detect anomalies in two-dimensional representations of log templates and timestamps using the training data and a binary classification loss. For example, the machine learning model includes a first transformer module and a second transformer module, and the first transformer module processes rows of the training data and the second transformer module processes columns of the training data to generate outputs which are stacked and then passed to a global summation layer of the machine learning model.

The global summation layer converts the stacked outputs from the first and second transformer modules into a batch×1 shaped matrix which is processed by a 1×1 layer of a multilayer perceptron of the machine learning model using a sigmoid function to derive a classification result (e.g., anomaly or non-anomaly). Once trained, the machine learning model receives input data describing a two-dimensional representation of log templates and timestamps. For instance, the input data is generated based on the log data in a same or similar manner as the training data is generated based on the log data, but the input data does not include any pseudo-labels.

The anomaly system processes rows of the two-dimensional representation described by the input data using the first transformer module and the anomaly system processes columns of the two-dimensional representation using the second transformer module of the machine learning model. In some examples, the anomaly system leverages class activation mapping to generate a class discriminative localization map that indicates particular regions of the two-dimensional representation used for discrimination (e.g., determining whether an anomaly is detected or not detected). Outputs from the first and second transformer modules are passed to the global summation layer of the machine learning model which generates a matrix having a batch×1 shape. This matrix is processed by the 1×1 layer of the multilayer perceptron using the sigmoid function to classify the input data as including a log anomaly.

In order to generate an interpretation of the log anomaly, the anomaly system leverages the class discriminative localization map to identify a particular log template included in the two-dimensional representation that contributes to the anomaly. The anomaly system extracts the particular log template from the input data and uses the extracted log template to generate an indication of the interpretation of the log anomaly for display in a user interface. For example, the interpretation is an explanation of the detected log anomaly.

Unlike conventional systems which are limited to generating binary classifications without interpretations or which require labeled training data, the described systems for detection and interpretation of log anomalies are capable of detecting anomalies and generating interpretations of the anomalies without using training data annotated by humans. By utilizing the autoencoder to learn the general distribution of the log data, and pseudo-labeling instances of the log data which do not follow the learned general distribution (e.g., based on the reconstruction loss threshold) to generate the training data used to train the machine learning model in this way, the described systems are not limited to implementations relative to a particular dataset describing log templates and timestamps. This is not possible in the conventional systems that are limited to implementations relative to datasets which are similar to labeled training data used to train the conventional systems.

### Term Examples

As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning. For example, the machine learning model is capable of including, but is not limited to, clustering, decision trees, support vector machines, linear regression, logistic regression, Bayesian networks, random forest learning, dimensionality reduction algorithms, boosting algorithms, transformers, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

As used herein, the term “log data” refers to data describing semi-structured log messages and corresponding timestamps printed by an application or a system of applications to record runtime information such as occurrences of events, non-occurrences of events, status changes, etc.

As used herein, the term “log template” refers to a version of a semi-structured log message that has been processed (e.g., using a parser) to remove noise and other information from raw content included in the semi-structured log message. Examples of noise and other information include variable information such as levels of importance, node information, auxiliary information, etc.

As used herein, the term “two-dimensional representation” of log templates and timestamps refers to a temporal grouping or a time window of log templates. By way of example, a first dimension of the two-dimensional representation corresponds to log templates and a second dimension of the two-dimensional representation corresponds to timestamps.

As used herein, the term “anomaly” or “log anomaly” refers to an instance of log data which is unexpected such as an instance of the log data which falls outside of a distribution of the log data by more than a threshold amount. By way of example, anomalies include an observed event type known to be associated with system instability, an observed event type which has not been previously observed, and so forth.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Environment

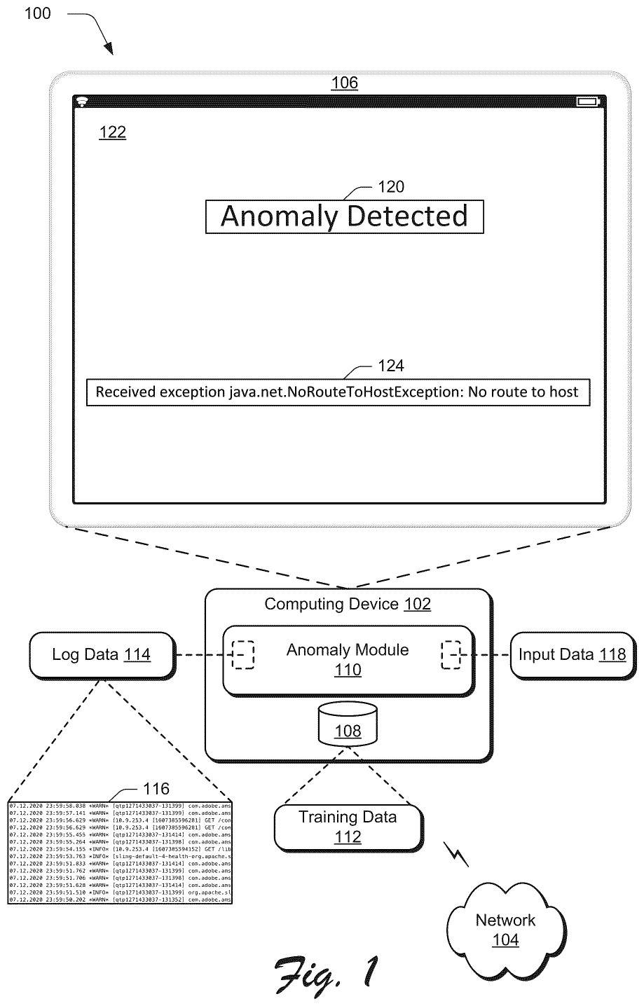

FIG. 1 is an illustration of an environment 100 in an example implementation that is operable to employ digital systems and techniques as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

The illustrated environment 100 also includes a display device 106 that is communicatively coupled to the computing device 102 via a wired or a wireless connection. A variety of device configurations are usable to implement the computing device 102 and/or the display device 106. For instance, the computing device 102 includes a storage device 108 and an anomaly module 110. The storage device 108 is illustrated to include training data 112 which the anomaly module 110 generates based on log data 114 in some examples.

The anomaly module 110 is illustrated as having, receiving, and/or transmitting the log data 114 which describes unprocessed log messages 116. In one example, the unprocessed log messages 116 are batched from historic runtime information. In another example, the anomaly module 110 receives the log data 114 describing the unprocessed log messages 116 in substantially real time (e.g., via the network 104) as the unprocessed log messages 116 are printed to record runtime information.

In some examples, the anomaly module 110 generates the training data 112 based on the log data 114 without labeling instances of anomalies included in the unprocessed log messages 116 using an autoencoder that is included in or available to the anomaly module 110. In these examples, anomaly module 110 implements the autoencoder to learn a general distribution of the log data 114. The anomaly module 110 then leverages the general distribution of the log data 114 to identify instances of the log data 114 which do follow the general distribution. These identified instances of the log data 114 are pseudo-labeled as anomalies, and the anomaly module 110 generates the training data 112 based on the pseudo-labeled anomalies.

In order to generate the training data 112 in one example, the anomaly module 110 processes the log data 114 using a log parser to remove irrelevant information from the unprocessed log messages 116 or to extract raw content from the unprocessed log messages 116. For example, the anomaly module 110 extracts log template and corresponding timestamps from the unprocessed log messages 116, and then groups the log templates into groups based on time windows of the corresponding timestamps. Consider an example in which the anomaly module 110 generates groups of log templates from the unprocessed log messages 116 in a sliding window implementation such that for an example data block timespan of 10 minutes and data increment time of 1 minute, the anomaly module 110 generates a first instance of a group of log templates using log templates having timestamps in a range of 0 to 10 minutes, a second instance of a group of log templates using log templates having timestamps in a range of 1 to 11 minutes, and so forth.

Continuing the example, the anomaly module 110 applies a count vectorizer to the instances of the groups of log templates to convert (e.g., vectorize) the grouped log templates into a numerical list in which each number signifies a count of a log message template. In one example, this vectorized data loses an ordering of the unprocessed log messages 116; however, the anomaly module 110 uses the vectorized data to train the autoencoder that is included in or available to the anomaly module 110. In this example, the anomaly module 110 trains the autoencoder using the vectorized data to detect anomalies in the log data 114 in an unsupervised manner. For instance, the autoencoder learns a general distribution of the vectorized data, and the anomaly module 110 identifies instances of the vectorized data that do not follow the general distribution of the vectorized data as anomalies.

To do so in one example, the anomaly module 110 leverages a reconstruction loss which is a normalized difference between input data received by an encoder of the autoencoder and output data generated by a decoder of the autoencoder. For example, the anomaly module 110 processes the vectorized data using the autoencoder and computes reconstruction losses for instances of the processed vectorized data. In one example, the anomaly module 110 labels (e.g., pseudo-labels) instances of the processed vectorized data having a reconstruction loss greater than a threshold (e.g., 3 percent) as an anomaly. In some examples, the anomaly module 110 performs postprocessing on the labeled vectorized data to generate the training data 112. For instance, the anomaly module 110 selects a same number of labeled anomaly samples and unlabeled non-anomaly samples from the labeled vectorized data. The anomaly module 110 then converts these samples into a concatenated matrix by applying counts from the count vectorizer to each data increment time to generate the training data 112 as describing two-dimensional representations of log templates and timestamps.

After generating the training data 112, the anomaly module 110 trains a machine learning model on the training data 112 to detect anomalies based on the labels generated by the autoencoder. For example, the machine learning model is included in or available to the anomaly module 110. In this example, the machine learning model includes a first transformer module and a second transformer module.

The anomaly module 110 implements the first transformer module to process rows of the two-dimensional representations and the anomaly module 110 implements the second transformer module to process columns of the two-dimensional representations described by the training data 112. In some examples, the anomaly module 110 uses class activation mapping to generate a class discriminative localization map that indicates which regions of a two-dimensional representation are used for discrimination (e.g., used to detect an anomaly). In these examples, the class discriminative localization map is usable to generate an interpretation of a detected anomaly by identifying a particular log template extracted from the log data 114 that contributes to the detected anomaly.

In order to detect anomalies, outputs of the first and second transformer modules are passed to a global summation layer of the machine learning model, and an output from the global summation layer is passed to a layer of a multilayer perceptron of the machine learning model. In an example, the anomaly module 110 leverages the layer of the multilayer perceptron and a sigmoid function to derive a classification result (e.g., a log anomaly is detected or a log anomaly is not detected). For instance, the anomaly module 110 uses a binary classification loss to update parameters of the machine learning model such that the model learns to accurately classify/detect anomalies in the log data 114.

After training the machine learning model to detect anomalies using the training data 112, the anomaly module 110 implements the trained machine learning model to process input data 118 describing two-dimensional representations of log templates and timestamps. For example, the input data 118 is generated based on the log data 114 in a same or similar way as the training data 112 is generated based on the log data 114 but without labeling the input data 118 using the autoencoder. Notably, it is possible for the anomaly module 110 to process the input data 118 using the autoencoder to determine whether the input data 118 describes a log anomaly (e.g., based on the learned general distribution of the log data 114). However, if an anomaly is detected in the input data 118 (e.g., based on a reconstruction loss between data received by the encoder of the autoencoder and data generated by the decoder of the autoencoder), then it is not possible for the anomaly module 110 to generate an interpretation of detected anomaly in an unsupervised manner using the autoencoder alone. For example, generating the interpretation of the detected anomaly would require additional analysis and/or processing of the input data 118 (e.g., by an analyst) which is burdensome and impractical in some scenarios (e.g., if the input data 118 describes many log templates).

In order to generate interpretations of detected anomalies without additional analysis (e.g., by an analyst), the anomaly module 110 processes the input data 118 using the trained machine learning model. For example, the anomaly module 110 implements the first transformer module to process rows of the two-dimensional representations described by the input data 118. In this example, the anomaly module 110 implements the second transformer module to process columns of the two-dimensional representations described by the input data 118.

Outputs of the first and second transformer modules are stacked and passed to the global summation layer of the machine learning model. An output from the global summation layer is passed to the layer of multilayer perceptron of the machine learning model. In some examples, the global summation process replicates the reconstruction loss of the autoencoder and the layer of the multilayer perceptron replicates the thresholding of the reconstruction loss used to detect anomalies in the log data 114. In an example, the anomaly module 110 leverages the layer of the multilayer perceptron and the sigmoid function to derive a classification result relative to a two-dimensional representation of log templates and timestamps described by the input data 118.

For instance, the anomaly module 110 generates an indication 120 of the classification result which is displayed in a user interface 122 of the display device 106. As shown, the indication 120 states “Anomaly Detected,” and the anomaly module 110 uses class activation mapping to generate a class discriminative localization map for the two-dimensional representation that includes the detected anomaly. For example, the class discriminative localization map indicates which region of the two-dimensional representation contributes to the detected anomaly. In this example, the anomaly module 110 identifies a particular log template associated with the indicated region and extracts the particular log template from the log data 114 to generate an indication 124 of an interpretation of the detected anomaly conveyed by the indication 120.

The indication 124 of the interpretation of the detected anomaly is also displayed in the user interface 122 and states “Received exception java.net.NoRouteToHostException: No route to host.” Thus, by leveraging the class discriminative localization map for the two-dimensional representation described by the input data 118 that includes the detected anomaly, it is possible for the anomaly module 110 to generate the indication 124 without additional processing of the input data 118 or an intervention (e.g., by an analyst). Furthermore, the anomaly module 110 is capable of generating the indication 124 of the interpretation of the detected anomaly in a fully unsupervised manner (e.g., when labeled data is not available for training). This is not possible in conventional systems that are limited to generating binary classifications (e.g., anomaly/non-anomaly) or which require labeled training data to learn to generate additional information about a binary classification.

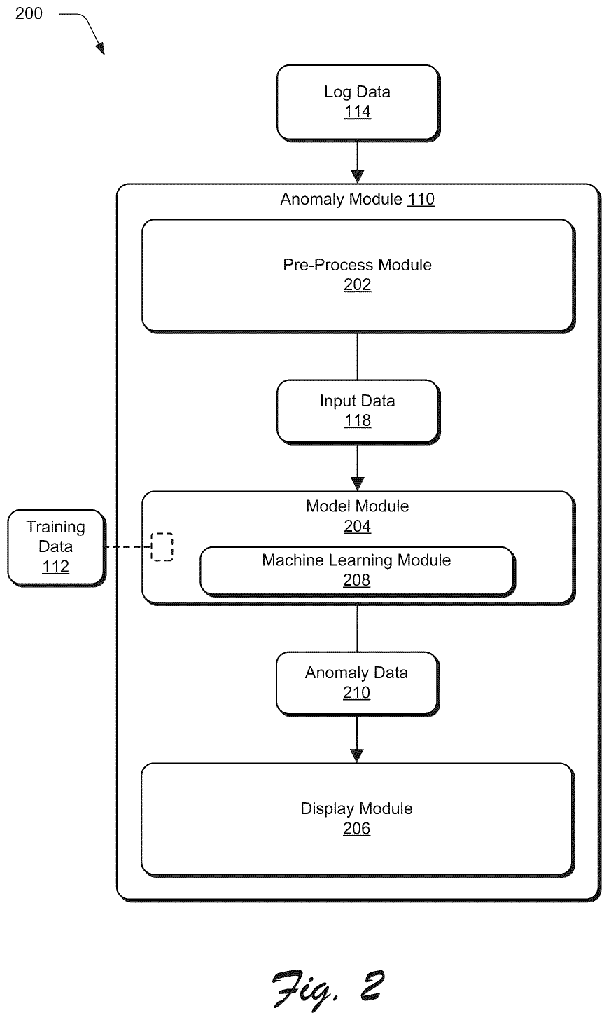

FIG. 2 depicts a system 200 in an example implementation showing operation of an anomaly module 110. The anomaly module 110 is illustrated to include a pre-process module 202, a model module 204, and a display module 206. For instance, the model module 204 includes a machine learning module 208, and the model module 204 is illustrated as having, receiving, and/or transmitting the training data 112. In an example, the pre-process module 202 receives and processes the log data 114 to generate the input data 118.

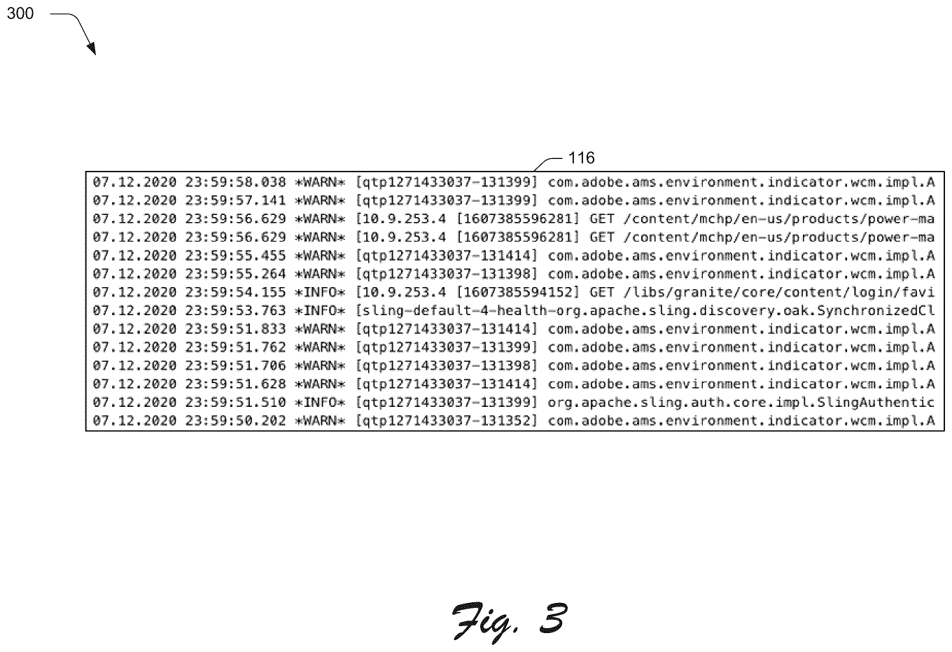

FIG. 3 illustrates a representation 300 of unprocessed log messages. As shown, the representation 300 includes the unprocessed log messages 116 described by the log data 114. For example, an instance of an unprocessed log message of the unprocessed log messages 116 includes a timestamp, an importance level, a node, raw content, and so forth.

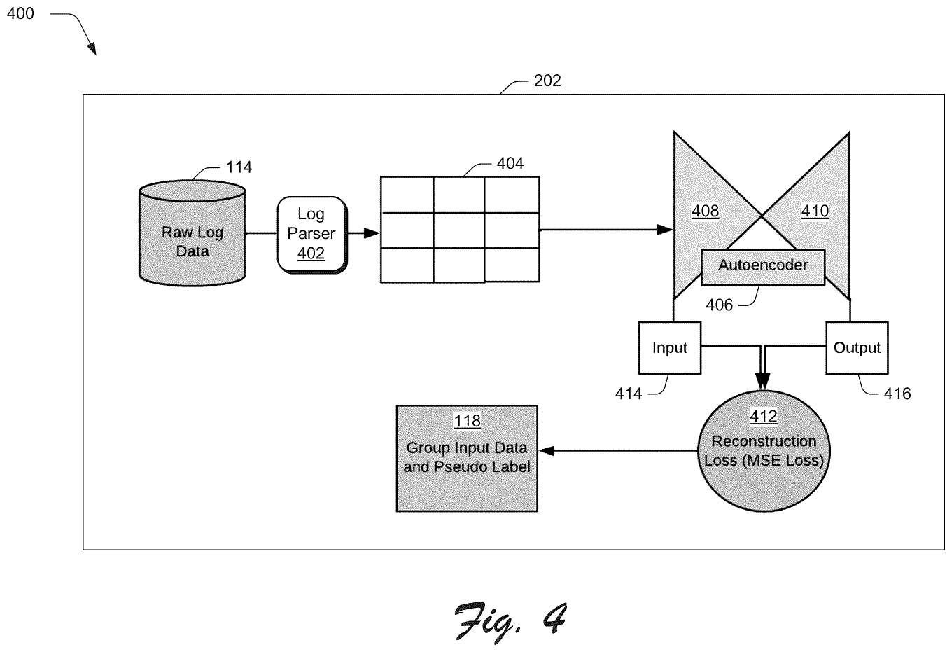

FIG. 4 illustrates a representation 400 of a pre-process module 202. In the illustrated example, the pre-process module 202 processes the log data 114 using a log parser 402 to extract raw content of each log message included in the unprocessed log messages 116. For example, the log parser 402 converts the extracted raw content into two-dimensional representations 404 of log templates and timestamps extracted from the unprocessed log messages 116 using the log parser 402.

In an example, the pre-process module 202 processes the log data 114 using a log parser 402 as described by He et al., Drain: An Online Log Parsing Approach with Fixed Depth Tree, 2017 IEEE 24th International Conference on Web Services, IEEE p. 33-40 (2017), to extract raw content of log messages from the unprocessed log messages 116 and convert the extracted raw content into the two-dimensional representations 404. To do so, the log templates are grouped into groups based on time windows of the timestamps. In one example, the pre-process module 202 groups the log templates into groups using a sliding temporal window such that for an example data block timespan of 10 minutes and data increment time of 1 minute, the pre-process module 202 generates a first group of log templates using log templates having timestamps in a range of 0 to 10 minutes, a second group of log templates using log templates having timestamps in a range of 1 to 11 minutes, a third group of log templates using log templates having timestamps in a range of 2 to 12 minutes, and so forth. The pre-process module 202 vectorizes the groups of log templates for processing by an autoencoder 406.

To vectorize the groups of log templates, the pre-process module 202 leverages the count vectorizer to convert the groups of log templates into a numerical list such that each number signifies a count of a log template. This vectorized result loses an ordering of the unprocessed log messages 116 but is usable to train the autoencoder 406 to detect anomalies in the log data 114 in an unsupervised manner. For evaluation purposes, the pre-process module 202 splits the vectorized representation of the groups of log templates into a training set and a testing set. In an example, rather than randomly splitting the training set and the testing set, the pre-process module 202 temporally splits the training set to be earlier in time than the testing set.

The autoencoder 406 includes an encoder 408 and a decoder 410 which are connected via a network bottleneck. During training, the network bottleneck causes the encoder 408 to compress original data included in the log data 114 which is to be decoded by the decoder 410. The autoencoder 406 learns a general distribution of the original data included in the log data 114 by iteratively encoding (e.g., compressing via the encoder 408) and decoding (e.g., decompressing via the decoder 410) the original data included in the log data 114. Once trained, the autoencoder 406 is usable to identify anomalies in the log data 114 by identifying instances of the log data 114 that do not follow the learned general distribution of the original data included log data 114.

To do so in one example, the pre-process module 202 computes a reconstruction loss 412 as a normalized difference between data that is input 414 to the encoder 408 and data that is output 416 from the decoder 410. For example, the pre-process module 202 generates anomaly labels or pseudo-labels by marking data that is input 414 to the encoder 408 which has a reconstruction loss 412 that is greater than a threshold reconstruction loss (e.g., 2 percent, 3 percent, 4 percent, etc.). In this manner, the pre-process module 202 trains the autoencoder 406 to detect anomalies in the log data 114 with or without having labels for the anomalies included in the log data 114.

In some examples, the pre-process module 202 generates the training data 112 based on the pseudo-labels that indicate anomalies detected by the autoencoder 406. In these examples, the pre-process module 202 generates the training data 112 by selecting an equal number of anomaly samples (e.g., having the pseudo-labels) and non-anomaly samples (e.g., not having the pseudo-labels). Once the equal number of anomaly/non-anomaly samples are selected, the pre-process module 202 converts the vectorized representation of the groups of log templates into a concatenated matrix by applying the count vectorizer to each data increment time.

As described above, the pre-process module 202 trains the autoencoder 406 using the groups of log templates generated using the sliding window for the example data block timespan of 10 minutes which avoids overfitting issues in the training. Since the machine learning model is more robust to overfitting issues during training than the autoencoder 406, the pre-process module 202 generates the training data 112 for training the machine learning model using the example data increment time of 1 minute. Consider an example in which the pre-process module 202 splits the first group of log templates with the log templates having timestamps in a range of 0 to 10 minutes which was used to train the autoencoder 406 into 10 subgroups. In this example, the 10 subgroups include a first subgroup of log templates having log templates with timestamps in a range of 0 to 1 minutes, a second subgroup of log templates having log templates with timestamps in a range of 1 to 2 minutes, a third subgroup of log templates having log templates with timestamps in a range of 2 to 3 minutes, and so forth. The pre-process module 202 then converts the vectorized representation of the groups of log templates into the concatenated matrix by applying the count vectorizer to the first subgroup of log templates having log templates with timestamps in the range of 0 to 1 minutes, the second subgroup of log templates having log templates with timestamps in the range of 1 to 2 minutes, the third subgroup of log templates having log templates with timestamps in the range of 2 to 3 minutes, etc.

The pre-process module 202 generates the training data 112 as describing the concatenated matrix in an example. The pre-process module 202 also generates the input data 118 in a same or similar manner as the pre-process module 202 generates the training data 112. In some examples, the pre-process module 202 simultaneously generates the training data 112 and the input data 118 and splits the training data 112 into a training dataset and the input data 118 into a testing dataset. In other examples, the pre-process module 202 generates the training data 112 using historic data included in the log data 114 and generates the input data 118 as describing current data included in the log data 114. For example, the pre-process module 202 generates the input data 118 as describing the log data 114 as the log data 114 is received in substantially real time, e.g., via the network 104.

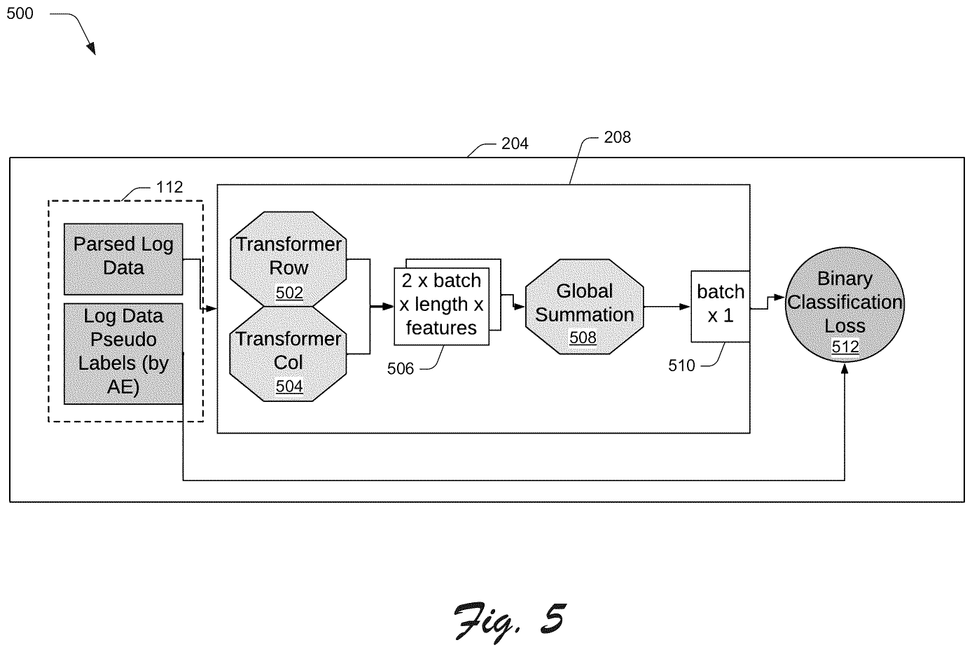

The model module 204 receives the training data 112 and the input data 118. For example, the machine learning model is included in or available to the machine learning module 208, and the model module 204 implements the machine learning module 208 to train the machine learning model on an anomaly detection task using the training data 112. FIG. 5 illustrates a representation 500 of training a machine learning model. The representation 500 includes the model module 204 and the machine learning module 208. For example, the machine leaning model is illustrated to include a first transformer module 502 and a second transformer module 504. In this example, the machine learning model receives the training data 112 as describing the concatenated matrix which is a two-dimensional representation of log templates and timestamps.

Consider an example in which the first transformer module 502 processes rows of the two-dimensional representation described by the training data 112 to identify temporal relationships and dependencies in the log data 114 and the second transformer module 504 processes columns of the two-dimensional representation described by the training data 112 to identify log template relationships and dependencies in the log data 114. Continuing the example, outputs 506 of the first transformer module 502 and the second transformer module 504 are stacked and passed to a global summation layer 508 of the machine learning model. The global summation layer 508 utilizes summation operators applied on all axes except for a batch. As a result, an output 510 of the global summation layer 508 is a vector of a size batch×1.

For example, the output 510 is passed through a layer of a multilayer perceptron or a 1×1 one layer perceptron, and a sigmoid function is applied to convert a resulting value between 0 and 1. Specifically, values between negative infinity and 0 are converted to a value less than 0.5 and values between 0 and positive infinity are converted to a value greater than 0.5. For instance, if an output of the sigmoid function is 0, then a corresponding datapoint is not an anomaly and vice versa. The model module 204 compares the output of the sigmoid function to the pseudo-labels described by the training data 112 to train the machine learning model by minimizing a binary classification loss 512. After training the machine learning model to detect anomalies using the training data 112 and the binary classification loss 512, the model module 204 implements the machine learning module 208 to process the input data 118 using the trained machine learning model.

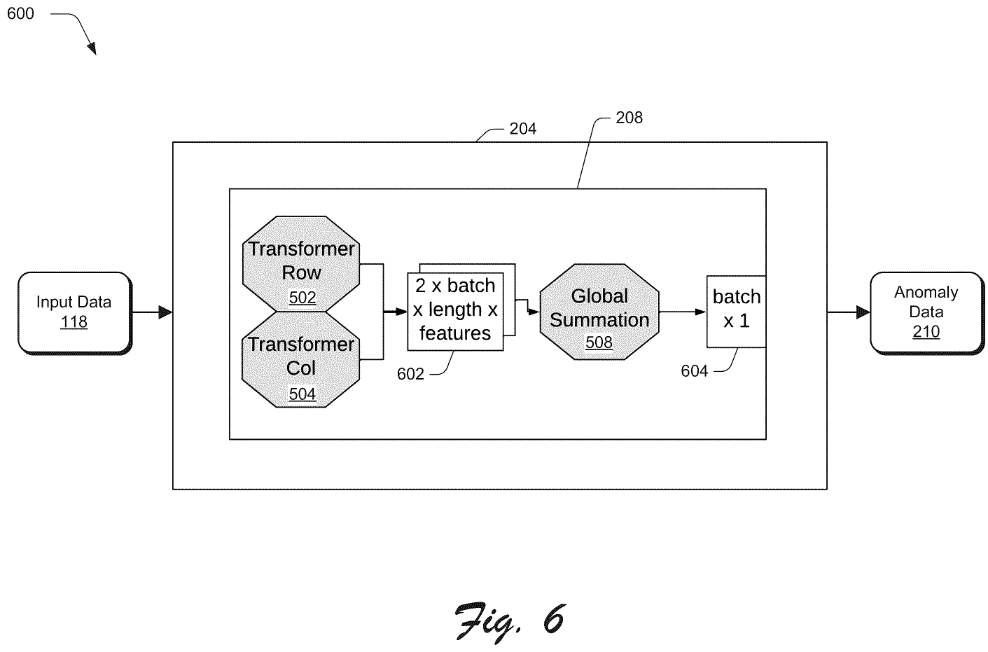

FIG. 6 illustrates a representation 600 of generating anomaly data using a trained machine learning model. The machine learning model receives the input data 118 as describing a two-dimensional representation of log templates and timestamps extracted from the unprocessed log messages 116. For example, the first transformer module 502 processes rows of the two-dimensional representation described by the input data 118. The second transformer module 504 processes columns of the two-dimensional representation described by the input data 118.

In an example, outputs 602 of the first transformer module 502 and the second transformer module 504 are passed to the global summation layer 508 of the machine learning model. Consider an example in which the input data 118 describes a 10×20 two-dimensional representation of the log templates and timestamps. In this example, the input data 118 describes 10 contiguous time slices (e.g., 10 consecutive timestamps) and 20 different types of log templates (e.g., 20 log templates). Continuing the example, the outputs 602 are 2×10×20 because the first transformer module 502 and the second transformer module 504 each generate a 10×20 output.

The machine learning model sums the outputs 602 with respect to an axis to generate a final 10×20 output matrix which is used to generate an interpretation of a detected anomaly. For example, all values within the final 10×20 output matrix are between 0 and 1, and a highest value in the cells of the final 10×20 output matrix likely corresponds to a particular log template contributing to a detected anomaly which is usable to generate the interpretation. Before generating the interpretation, the global summation layer 508 generates an output 604 based on the outputs 602 which is a matrix having a shape of batch×1. The 1×1 perceptron layer of the machine learning model processes the output 604 using the sigmoid function to derive a classification result for the input data 118 (e.g., an anomaly is detected or no anomaly is detected). After applying the sigmoid function, the 1×1 perceptron layer (e.g., or the layer of the multilayer perceptron) outputs a value between 0 and 1. If this value is above 0.5, then an anomaly is detected and if the value is below 0.5, then no anomaly is detected.

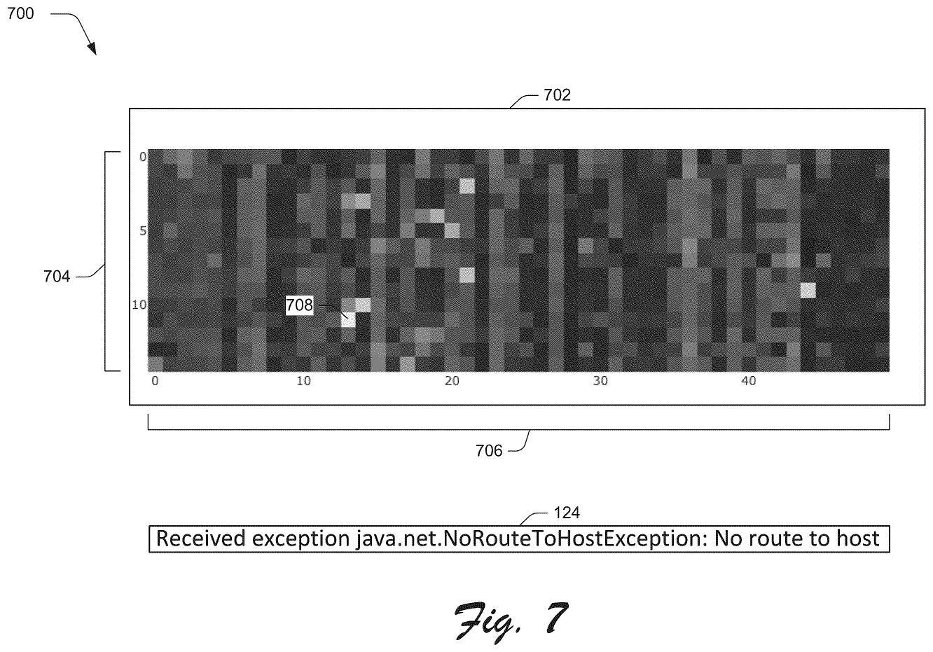

FIG. 7 illustrates a representation 700 of generating an indication of an interpretation of a log anomaly. Consider an example in which the value output by the 1×1 perceptron layer of the machine learning model indicates that an anomaly is detected in the input data 118 (e.g., the value output from the 1×1 perceptron layer is greater than 0.5). In this example, the model module 204 performs class activation mapping relative to the outputs 602 to generate a class discriminative localization map 702. As shown, the class discriminative localization map 702 is a two-dimensional representation of timestamps 704 and log templates 706.

In an example, the class discriminative localization map 702 is a visual representation of the final 10×20 output matrix, and colors depicted by the class discriminative localization map 702 correspond to the values included in the final 10×20 output matrix that are usable to identify a particular log template that contributes to the detected anomaly in the input data 118. For example, darker colors of the class discriminative localization map 702 correspond to relatively low values included in the final 10×20 output matrix. Conversely, lighter colors of the class discriminative localization map 702 correspond to relatively high values included in the final 10×20 output matrix.

The model module 204 identifies a lightest color 708 of the class discriminative localization map 702 as corresponding to a highest value included in the final 10×20 output matrix. For example, the model module 204 extracts a particular log template from the input data 118 that corresponds to the highest value included in the final 10×20 output matrix. In an example, the model module 204 generates anomaly data 210 describing the extracted log template. The display module 206 receives and processes the anomaly data 210 to generate the indication 124 of the interpretation of the detected anomaly. For instance, the display module 206 displays the indication 124 in the user interface 122 of the display device 106. The indication 124 states “Received exception java.net.NoRouteToHostException: No route to host” which indicates a reason why an anomaly is detected.

Unlike conventional systems which are limited to detecting anomalies without generating interpretations of detected anomalies or which require labeled training data, the described systems for detection and interpretation of log anomalies are capable of detecting anomalies and generating interpretations of the anomalies with or without labeled training data. By utilizing the autoencoder 406 to learn the general distribution of the log data 114, and pseudo-labeling instances of the log data 114 which do not follow the learned general distribution (e.g., based on a reconstruction loss threshold) to generate the training data 112 used to train the machine learning model in this way, the described systems for detection and interpretation of log anomalies are not limited to implementations relative to a particular dataset describing log templates and timestamps. This is not possible in the conventional systems that require labeled training data which are limited to implementations relative to datasets which are similar to the labeled training data.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### EXAMPLE PROCEDURES

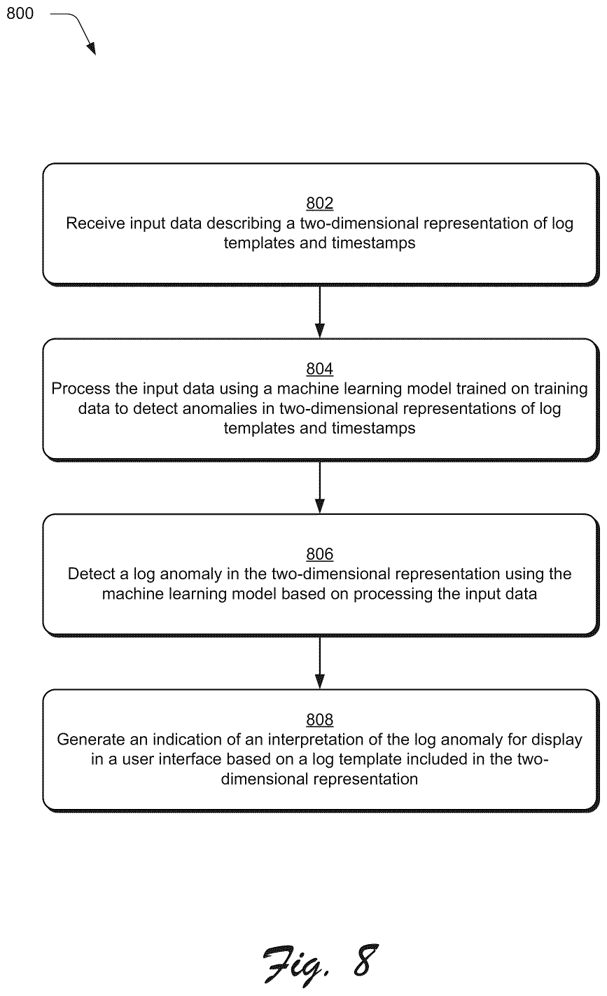

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-7. FIG. 8 is a flow diagram depicting a procedure 800 in an example implementation in which an indication of an interpretation of a log anomaly is generated for display in a user interface.

Input data is received describing a two-dimensional representation of log templates and timestamps (block 802). For example, the computing device 102 implements the anomaly module 110 to receive the input data. The input data is processed using a machine learning model trained on training data to detect anomalies in two-dimensional representations of log templates and timestamps (block 804). In one example, the anomaly module 110 processes the input data using the machine learning model.

A log anomaly is detected in the two-dimensional representation using the machine learning model based on processing the input data (block 806). In some examples, the anomaly module 110 detects the log anomaly in the two-dimensional representation. An indication of an interpretation of the log anomaly is generated for display in a user interface based on a log template included in the two-dimensional representation (block 808). For example, the anomaly module 110 generates the indication of the interpretation of the log anomaly for display in the user interface.

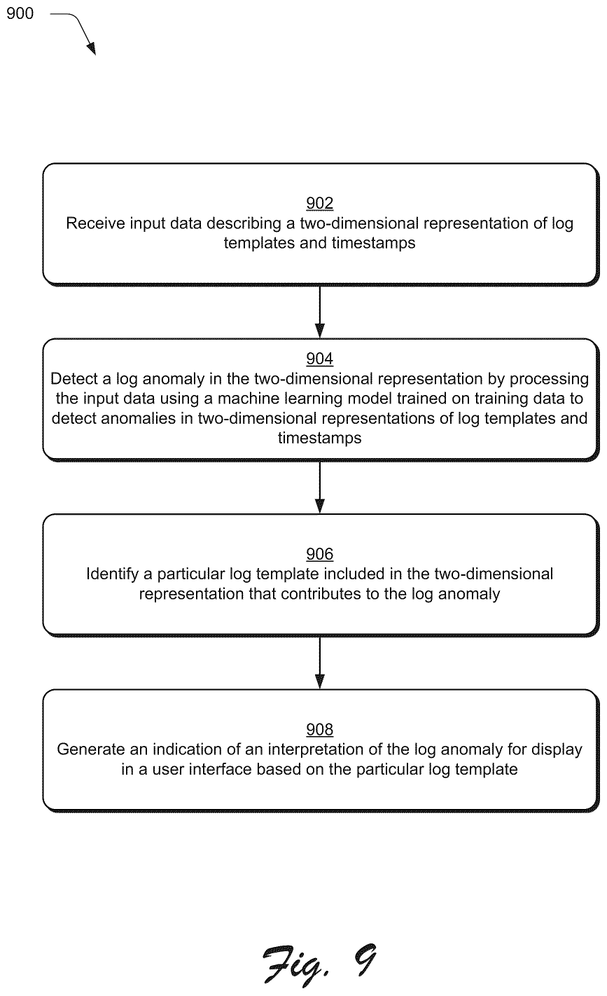

FIG. 9 is a flow diagram depicting a procedure in an example implementation in which a particular log template included in a two-dimensional representation is identified as contributing to a log anomaly detected in the two-dimensional representation. Input data is received describing a two-dimensional representation of log templates and timestamps (block 902). In an example, the computing device 102 implements the anomaly module 110 to receive the input data. A log anomaly is detected in the two-dimensional representation by processing the input data using a machine learning model trained on training data to detect anomalies in two-dimensional representations of log templates and timestamps (block 904). For example, the anomaly module 110 detects the log anomaly in the two-dimensional representation.

A particular log template included in the two-dimensional representation is identified that contributes to the log anomaly (block 906). In some examples, the anomaly module 110 identifies the particular log template included in the two-dimensional representation that contributes to the log anomaly. An indication of an interpretation of the log anomaly is generated for display in a user interface based on the particular log template (block 908). In one example, the computing device 102 implements the anomaly module 110 to generate the indication of the interpretation of the log anomaly.

### Example System and Device

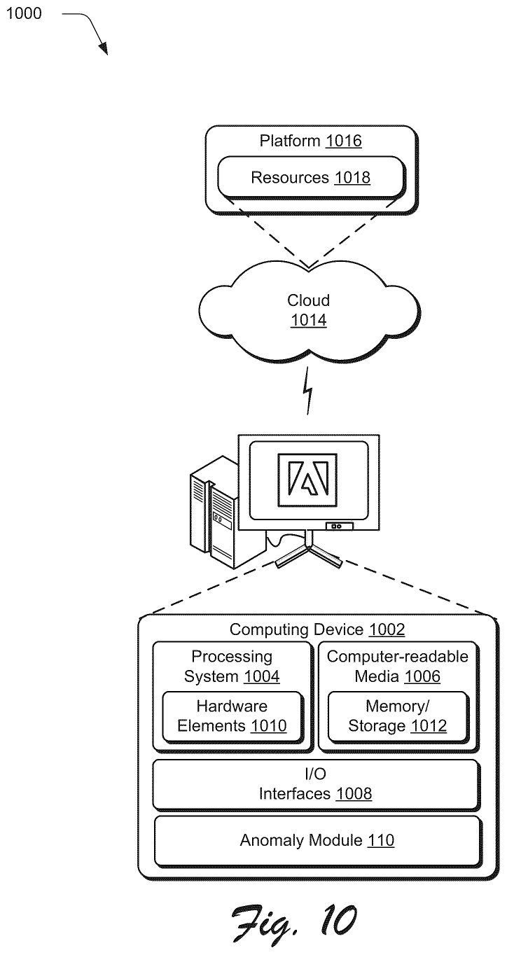

FIG. 10 illustrates an example system 1000 that includes an example computing device that is representative of one or more computing systems and/or devices that are usable to implement the various techniques described herein. This is illustrated through inclusion of the anomaly module 110. The computing device 1002 includes, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interfaces 1008 that are communicatively coupled, one to another. Although not shown, the computing device 1002 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware elements 1010 that are configured as processors, functional blocks, and so forth. This includes example implementations in hardware as an application specific integrated circuit or other logic device formed using one or more semiconductors. The hardware elements 1010 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1006 is illustrated as including memory/storage 1012. The memory/storage 1012 represents memory/storage capacity associated with one or more computer-readable media. In one example, the memory/storage 1012 includes volatile media (such as random access memory (RAM)) and/or nonvolatile media (such as read only memory (ROM), Flash memory, optical disks, magnetic disks, and so forth). In another example, the memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 1010. For example, the computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices 1002 and/or processing systems 1004) to implement techniques, modules, and examples described herein.

The techniques described herein are supportable by various configurations of the computing device 1002 and are not limited to the specific examples of the techniques described herein. This functionality is also implementable entirely or partially through use of a distributed system, such as over a “cloud” 1014 as described below.

The cloud 1014 includes and/or is representative of a platform 1016 for resources 1018. The platform 1016 abstracts underlying functionality of hardware (e.g., servers) and software resources of the cloud 1014. For example, the resources 1018 include applications and/or data that are utilized while computer processing is executed on servers that are remote from the computing device 1002. In some examples, the resources 1018 also include services provided over the Internet and/or through a subscriber network, such as a cellular or Wi-Fi network.

The platform 1016 abstracts the resources 1018 and functions to connect the computing device 1002 with other computing devices. In some examples, the platform 1016 also serves to abstract scaling of resources to provide a corresponding level of scale to encountered demand for the resources that are implemented via the platform. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

### CONCLUSION

Although implementations of systems for detection and interpretation of log anomalies have been described in language specific to structural features and/or methods, it is to be understood that the appended claims are not necessarily limited to the specific features or methods described. Rather, the specific features and methods are disclosed as example implementations of systems for detection and interpretation of log anomalies, and other equivalent features and methods are intended to be within the scope of the appended claims. Further, various different examples are described and it is to be appreciated that each described example is implementable independently or in connection with one or more other described examples.

What is claimed is:

1. A method comprising:
receiving, by a processing device, input data describing a two-dimensional representation of log templates and timestamps;
processing, by the processing device, the input data using a machine learning model trained on training data to detect anomalies in two-dimensional representations of log templates and timestamps;
detecting, by the processing device, a log anomaly in the two-dimensional representation using the machine learning model based on processing the input data; and
generating, by the processing device, an indication of an interpretation of the log anomaly for display in a user interface based on a log template included in the two-dimensional representation.

2. The method as described in claim 1, wherein the interpretation of the log anomaly is generated using class activation mapping.

3. The method as described in claim 1, wherein the machine learning model is trained using a binary classification loss.

4. The method as described in claim 1, wherein the machine learning model includes a first transformer module and a second transformer module.

5. The method as described in claim 4, wherein the first transformer module is implemented to process rows of the two-dimensional representation and the second transformer module is implemented to process columns of the two-dimensional representation.

6. The method as described in claim 4, wherein the log anomaly is detected by processing outputs of the first transformer module and the second transformer module using a global summation layer of the machine learning model.

7. The method as described in claim 1, wherein the log anomaly is detected using a layer of a multilayer perceptron of the machine learning model and a sigmoid function.

8. The method as described in claim 1, wherein the training data is generated by processing log data describing vectorized log templates using an autoencoder.

9. The method as described in claim 8, wherein the training data describes training samples classified based on a reconstruction loss between inputs to an encoder of the autoencoder and outputs from a decoder of the autoencoder.

10. A system comprising:
a memory component; and
a processing device coupled to the memory component, the processing device to perform operations comprising:
receiving input data describing a two-dimensional representation of log templates and timestamps;
detecting a log anomaly in the two-dimensional representation by processing the input data using a machine learning model trained on training data to detect anomalies in two-dimensional representations of log templates and timestamps;
identifying a particular log template included in the two-dimensional representation that contributes to the log anomaly; and
generating an indication of an interpretation of the log anomaly for display in a user interface based on the particular log template.

11. The system as described in claim 10, wherein the particular log template is identified using class activation mapping.

12. The system as described in claim 10, wherein the machine learning model includes a first transformer module, a second transformer module, and a global summation layer.

13. The system as described in claim 12, wherein the first transformer module is implemented to process rows of the two-dimensional representation and the second transformer module is implemented to process columns of the two-dimensional representation.

14. The system as described in claim 12, wherein the log anomaly is detected by processing outputs of the first transformer module and the second transformer module using the global summation layer.

15. The system as described in claim 10, wherein the log anomaly is detected using a layer of a multilayer perceptron of the machine learning model and a sigmoid function.

16. A non-transitory computer-readable storage medium storing executable instructions, which when executed by a processing device, cause the processing device to perform operations comprising:
receiving input data describing a two-dimensional representation of log templates and timestamps;
processing the input data using a machine learning model trained on training data to detect anomalies in two-dimensional representations of log templates and timestamps;
detecting a log anomaly in the two-dimensional representation using the machine learning model based on processing the input data; and
generating an indication of an interpretation of the log anomaly for display in a user interface based on a log template included in the two-dimensional representation.

17. The non-transitory computer-readable storage medium as described in claim 16, wherein the machine learning model includes a first transformer module implemented to process rows of the two-dimensional representation and a second transformer module implemented to process columns of the two-dimensional representation.

18. The non-transitory computer-readable storage medium as described in claim 17, wherein the log anomaly is detected by processing outputs of the first transformer module and the second transformer module using a global summation layer of the machine learning model.

19. The non-transitory computer-readable storage medium as described in claim 16, wherein the log anomaly is detected using a layer of a multilayer perceptron of the machine learning model and a sigmoid function.

20. The non-transitory computer-readable storage medium as described in claim 16, wherein the interpretation of the log anomaly is generated using class activation mapping.
